(19) United States
(12) Patent Application Publication
(10) Pub. No.: US 2023/0262562 A1
(43) Pub. Date: Aug. 17, 2023

(54) TECHNOLOGIES FOR OFFLOADING PATHS FROM EDGE COMPUTING RESOURCES

(71) Applicant: Apple Inc., Cupertino, CA (US)

(72) Inventors: Sudeep Manithara Vamanan, Nuremberg (DE); Haijing Hu, Los Gatos, CA (US); Krisztian Kiss, Hayward, CA (US); Mona Agnel, Uxbridge (GB)

(73) Assignee: Apple Inc., Cupertino, CA (US)

(21) Appl. No.: 18/106,332

(22) Filed: Feb. 6, 2023

Related U.S. Application Data
(60) Provisional application No. 63/310,047, filed on Feb. 14, 2022.

(51) Int. Cl. H04W 36/22; H04W 36/30

(52) U.S. Cl. CPC H04W 36/22; H04W 36/30

(57) ABSTRACT

The present application relates to devices and components including apparatuses, systems, and methods for technologies for offloading paths from edge computing resources.

### CROSS-REFERENCE TO RELATED APPLICATION

This application claims the benefit of U.S. Provisional Patent Application No. 63/310,047, filed on Feb. 14, 2022, which is herein incorporated by reference in its entirety for all purposes.

### BACKGROUND

Third Generation Partnership Project (3GPP) Technical Specifications (TSs) define standards for New Radio (NR) wireless networks. One area of study for developing these TSs is for enhancing utilization of edge computing resources.

### BRIEF DESCRIPTION OF THE DRAWINGS

FIG. 1 illustrates a network environment in accordance with some embodiments.

FIG. 2 illustrates an offload operation in accordance with some embodiments.

FIG. 3 illustrates a configuration operation in accordance with some embodiments.

FIG. 4 illustrates an operational flow/algorithmic structure in accordance with some embodiments.

FIG. 5 illustrates another operational flow/algorithmic structure in accordance with some embodiments.

FIG. 6 illustrates another operational flow/algorithmic structure in accordance with some embodiments.

FIG. 7 illustrates a user equipment in accordance with some embodiments.

FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, or network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

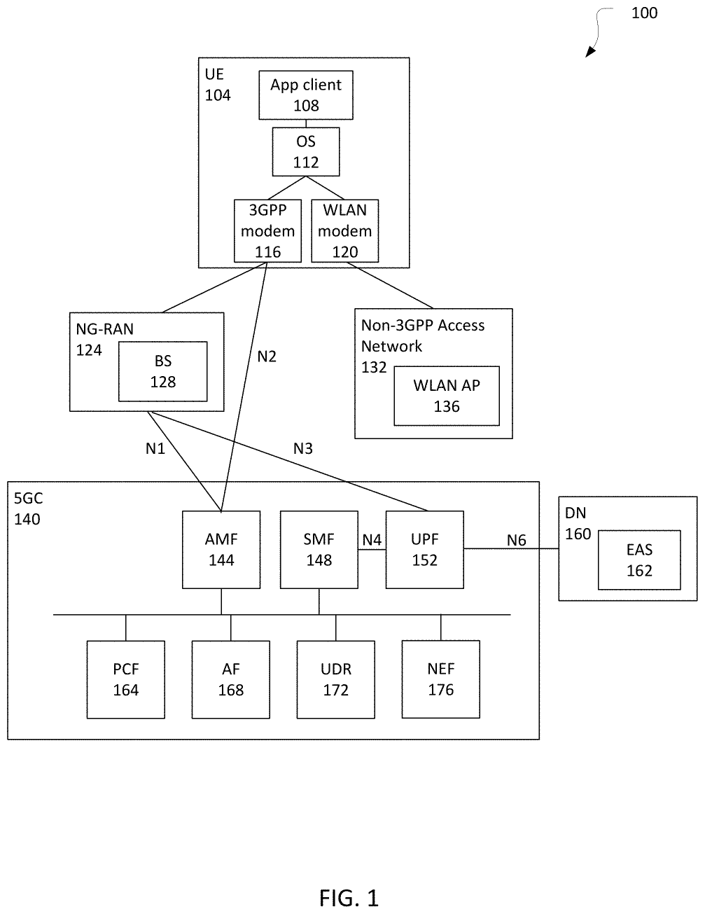

FIG. 1 illustrates a network environment 100 in accordance with some embodiments. The network environment 100 may include a user equipment (UE) 104 with an application client 108, an operating system (OS) 112, and a plurality of wireless interfaces including a 3GPP modem 116 and a wireless local area network (WLAN) modem 120. Application traffic of the application client 108 may be transmitted to, or received from, a network entity via one or more wireless interfaces.

The 3GPP modem 116 may be communicatively coupled with a next generation-radio access network (NG-RAN) 124 that includes a base station (BS) 128. The UE 104 and the BS 128 may communicate over air interfaces compatible with 3GPP TSs such as those that define Fifth Generation System (5GS) standards. The BS 128 may be a next generation node B (gNB) to provide one or more 5G New Radio (NR) cells that present NR user plane and control plane protocol terminations toward the UE 104.

The WLAN modem 120 may be communicatively coupled with a non-3GPP access network 132 that may include a WLAN AP 136.

The NG-RAN 124 may be coupled with a 5G core (5GC) 140. The NG-RAN 124 and the 5GC 140 may be referred to as 5G System (5GS).

The 5GC 140 may include an access and mobility function (AMF) 144, a session management function (SMF) 148, a user plane function (UPF) 152 coupled with a data network (DN) 160, a policy control function (PCF) 164, an application function (AF) 168, a unified data repository (UDR) 172, and a network exposure function (NEF) 176. The functions of the 5GC 140 may be implemented in one or more servers.

The AMF 144 may be responsible for registration management (e.g., for registering the UE 104), connection management, reachability management, mobility management, lawful interception of AMF-related events, and access authentication and authorization.

The SMF 148 may configure traffic steering, quality of service (QoS) control and policy related functions at the UPF 152, perform protocol data unit (PDU) session management, Internet protocol (IP) address allocation, general packet radio service tunneling protocol—user plane (GTP-U) tunnel management, selection and control of user plane functions, and downlink notification management.

The UPF 152 may handle the user plane path of PDU sessions to facilitate routing of traffic to and from the DN 160. The DN 160 may include an edge application server (EAS) 162 that is resident in an edge hosting environment that provides support for the EAS 162. The EAS 162 may be in a local part of the DN 160, which may refer to the set of network entities of the DN 160 that are deployed locally, for example, near the BS 128. The use of local (or “edge”) computing resources may enable efficient delivery of network services by reducing end-to-end latency and load in the 5GS.

In some embodiments, a number of UPFs may be involved in providing service to the UE 104. For example, a first UPF may provide an uplink classifier/branching point (UL CL/BP) to divert local traffic to local data networks based on traffic matching filters, a second UPF may provide a central PDU session anchor (C-PSA) to couple with a central part of the DN 160, and a third UPF may provide a local PDU session anchor (L-PSA) to couple with a local part of the DN 160 (L-DN) that provides the EAS 162. In this context, the third UPF may also be referred to as a “local UPF.”

The PCF 164 may provide session management related functionality including policy and charging control for service data flows (SDFs), PDU session related policy control, and PDU session event reporting to the AF 168.

The AF 168 may offer applications that may require dynamic policy or charging control over IP-connectivity access network (CAN) user plane behavior.

The UDR 140 may manage and store subscriber/subscription-related data.

In some instances, the UE 104 may have connectivity options from both the NG-RAN 124 and the non-3GPP access network 132. The UE 104 may have various policies to address these access options. A first policy may be referred to as access network discovery and selection protocol (ANDSP), which may influence WLAN selection and prioritization of WLANs. For example, a mobile network operator (MNO)-deployed WLAN may be prioritized over a private WLAN.

The second policy may be referred to as a UE route selection policy (URSP). The URSP works at the traffic descriptor level (for example, traffic targeting a fully qualified domain name or application/application categories) to route outgoing traffic. The URSP influences the application traffic path. For example, the URSP may be used to determine whether traffic is to be routed to an established PDU Session, offloaded to non-3GPP access outside a PDU Session, routed via a ProSe Layer-3 UE-to-Network Relay outside a PDU session, or through a new PDU Session.

The third policy may be referred to as access traffic steering, switching, and splitting (ATSSS). An ATSSS rule is part of a PDU session that is used to influence how to split/steer/switch an IP flow between 3GPP access and non-3GPP access.

The network environment 100 may leverage edge computing technology to improve efficiency of delivering services through the 3GPP networks. Edge computing technology may include edge discovery and re-discovery enhancements and features to help efficient relocation of edge computing resources. The UE 104 may need to avoid switching edge computing (EC) traffic away from an EC PDU session in 5GS due to connectivity preferences in the UE 104. Consider, for example, that an MNO has an edge deployment and the UE 104 is communicating with EAS 162 over the 3GPP access link. If the UE 140 detects a suitable non-3GPP access (for example, WLAN AP 136) that is not integrated with the MNO, the UE 140 may have local configurations to offload the application traffic to the WLAN and totally bypass the cellular network. However, such an autonomous decision by the UE 140 may lead to performance degradation if the Internet protocol (IP) point-of-presence accessible through the WLAN AP 136 is far away and the UE-to-application server (AS) communication takes longer.

Embodiments provide guidance for the UE 104 with respect to offloading traffic from an edge-enabled PDU session to a WLAN. Behavior of the UE 104 may be controlled by the network dynamically helping to decide the best interface for the traffic and informing the UE 104 of this decision. In this case, since the network is not in control of the alternate paths available to the UE 104, the network may only help to provide information about the condition of the UE's PDU session carrying edge computing traffic. This information may include round-trip time (RTT) measurements between the UE 104 and the EAS 162. If the UE 104 determines an alternate path may provide better performance, the UE 104 may decide to switch traffic.

Behavior of the UE 104 may additionally/alternatively be controlled by the network providing static guidance or priority order for interface selection. This may be provided in addition to existing UE policy parameters such as the URSP.

In some embodiments, edge computing traffic offload to non-3GPP access networks (for example, a WLAN) may be managed by enhancements to the URSP. For example, a WLAN Offload Guidance component may be added to a route selection descriptor (RSD) of an URSP rule. The WLAN Offload Guidance component may be present in an RSD that describes a PDU session (for example, a 3GPP access). Table 1 below shows a USRP format in accordance with an embodiment.

TABLE 1

| | |
|---|---|
| Traffic | RSD precedence 1, PDU Session Parameters (DNN, |
| Descriptor A | S-NSSAI, SSC mode), WLAN Offload Guidance = True |
| | RSD precedence 2, PDU Session Parameters (DNN, |
| | S-NSSAI, SSC mode) |

The WLAN Offload Guidance component may be a one bit field that indicates whether the decision of offloading traffic matching the traffic descriptor for that URSP rule is conditional. For example, if the bit is set (indicating the WLAN Offload Guidance=True), the offloading of the traffic is conditional according to a first rule or second rule. The first rule may indicate that if the UE 104 is informed that traffic corresponding to the traffic descriptor is served by an edge DN entity over cellular, the UE 104 is not allowed to offload the traffic to non-3GPP access. The second rule may indicate that the UE 104 may offload the traffic if certain conditions are met with respect to RTT measurements. For example, detection of a competing non-3GPP access to potentially offload traffic may trigger the UE 104 to perform RTT measurements on one or both of the 3GPP and non-3GPP links. In some embodiments, the UE 104 may not offload traffic to the non-3GPP link if the RTT for the alternate path (for example, via the non-3GPP link) is not better than the RTT computed for the 3GPP link that supports the cellular EC PDU session. If the non-3GPP link is better than the 3GPP link, the UE 104 may offload traffic to the non-3GPP link if desired. In some examples, as will be described in further detail herein, the non-3GPP link may need to be better than the 3GPP link by a predetermined threshold before allowing the UE 104 to offload traffic to the non-3GPP link.

In some embodiments, a component may be introduced in a RSD as an attribute to a PDU session “EC-enabled-PDU Session.” If the UE 104 detects this component, it may determine that the corresponding PDU session is optimized for edge services. The UE 104 may then consider this route to be prioritized over a non-integrated non-3GPP access for the traffic identified by the traffic descriptor. With this indication, there may be no dynamic control, for example, there may be no performance measurements or waiting for indication in PDU session of whether the UE 104 is to be served by edge resources. The UE 104 is just made aware that there is a possibility that the traffic in this PDU session may be served by edge resources, and the UE 104 may take this information into account before selecting an alternative network interface.

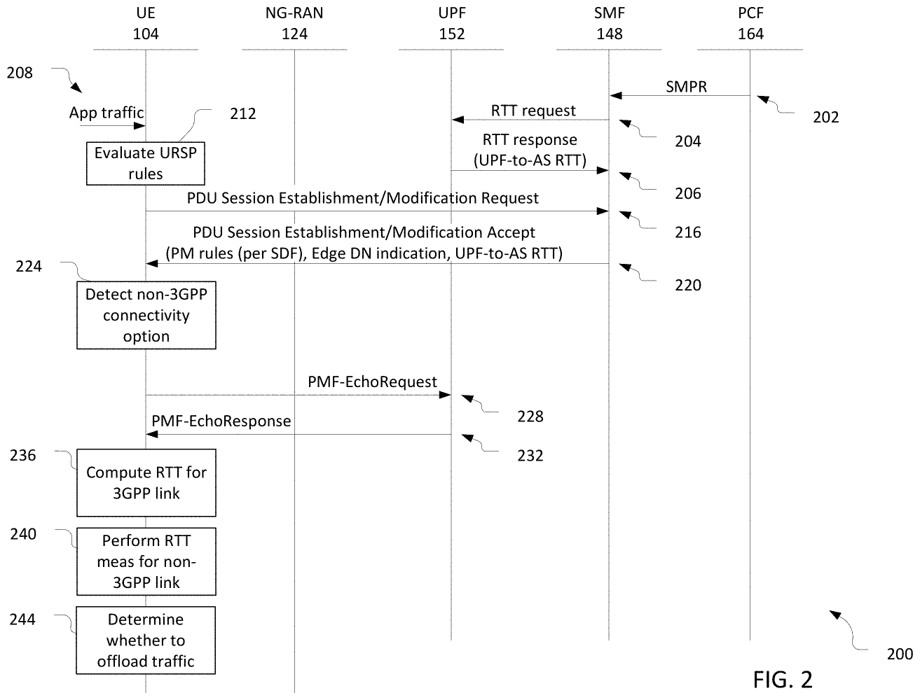

FIG. 2 illustrates an offload operation 200 in accordance with some embodiments.

At 202, the SMF 148 may receive session management policy rules (SMPR) from the PCF 164. The SMPR may provide the rules for charging control, policy control, or application detection and control.

At 204, the offload operation 200 may include the SMF 136 transmitting an RTT request to the UPF 132. The RTT request may request the UPF 132 to perform RTT measurements with an AS to obtain a UPF-to-AS RTT. The request may be sent at the time of adding an SDF to a QoS flow or when a new UL CL/BP is inserted. The UPF 132 may provide the UPF-to-AS RTT to the SMF 136 in an RTT response at 206.

At 208, the offload operation 200 may include the UE receiving application traffic (for example, application PDUs) from an application layer (for example, application client 108) of the UE 104.

At 212, the UE 104 may evaluate a URSP stored at the UE 104. The URSP rules may be initial provisioned to the UE 104 at a time of registration. The UE 104 may use the URSP rules to determine whether the application traffic is to be associated with a new PDU session or with an existing PDU session.

At 216, the UE 104 may transmit a PDU session establishment/modification request to the SMF 136. If the UE 104 determines, at 212, that the application traffic is to be associated with a new PDU session, the message transmitted to the SMF 136 may be a PDU session establishment request. If the UE 104 determines, at 212, that the application traffic is to be added with an existing PDU session, the message transmitted to the SMF 136 may be a PDU session modification request.

At 220, the SMF 136 may reply to the UE 104 by transmitting a PDU session establishment/modification accept message. This message may be used to inform the UE 104 of the dynamic condition of an EC PDU session. In particular, the PDU session establishment/modification accept message may provision the UE 104 with performance measurement (PM) rules, an edge DN indication, or UPF-to-AS RTT.

The PM rules, which may be provided per SDF, may include measurement system information used to perform measurements on a target QoS flow. The measurement assistance information may include a performance measurement function (PMF) address (for example, an IP address and port number) for RTT measurements on 3GPP access, traffic offloading rules (for example, an absolute threshold or an offset for comparison), or a PMF address for non-3GPP access (if the non-3GPP access as integrated).

The edge DN indication may indicate whether the current PDU session has an active network routing for the traffic, identified by the traffic descriptor in the URSP rule, to be routed to local resources (for example, a local UPF or EAS of an edge hosting environment).

At 224, the UE 104 may detect a non-3GPP connectivity option. For example, the WLAN modem 120 may detect the presence of the WLAN AP 136 and the UE 104 may determine that the non-3GPP path via the WLAN AP 136 is suitable for the application traffic received at 208.

In some embodiments, if there is an indication that the current PDU session has active network routing for edge traffic, the UE 104 may determine that it is not able to offload the application traffic out of the 3GPP access to the non-3GPP access network 132. The UE 104 may determine the current PDU session has active network routing for edge traffic based on the edge DN indication in the PDU session establishment/modification accept message. In this instance, the procedure 200 may skip to the UE determination of whether to offload traffic at 244. In these embodiments, the PM rules and UPF-to-AS RTT information may not be provided in the PDU session establishment/modification accept message received at 220.

In other embodiments, the PDU session establishment/modification accept message received at 220 may include the PM rules (and, optionally, the UPF-to-AS RTT information) and the UE 104 may proceed to trigger EC RTT measurements on 3GPP access and non-3GPP access paths.

The UE 104 may perform the RTT measurement on the 3GPP access using a PMF protocol toward the UPF 152. In particular, at 228, the UE 104 may transmit a PMF-EchoRequest to the UPF 152 using the PMF address provided in the PDU session establishment/modification accept message received at 220. At 232, the UE 104 may receive a PMF-EchoResponse from the UPF 152. The UE 104 may calculate a UE-to-UPF RTT based on these messages. If the UPF-to-AS RTT was provided by the SMF 148, the UE 104 may add the value to the UE-to-UPF RTT to determine a total UE-to-AS RTT.

At 240, the UE may perform RTT measurement for the non-3GPP link. Performance of the RTT measurement for the non-3GPP link may be based on whether the non-3GPP access network 132 is integrated with the 5GC 140. If it is integrated, the UE 104 may perform the non-3GPP RTT measurement in a manner similar to the 3GPP RTT measurement. For example, the UE 104 may send an echo request message to the UPF 152 over the non-3GPP link using the PMF address received from the SMF 148 and receive an echo response message from the UPF 152 over the non-3GPP link. If the non-3GPP access network 132 is not integrated with the 5GC 140, the RTT measurement may be done in a UE-implementation specific manner.

At 244, the UE 104 may determine whether to offload traffic. If the UE 104 performed the RTT measurements, the determination at 244 may be based whether certain conditions are met with respect to RTT measurements. The determination may be based on one or more absolute RTT threshold values or relative RTT threshold values. An embodiment may use an absolute RTT threshold value by providing that the UE 104 is not to offload traffic if the RTT over the 3GPP link is less than the absolute RTT threshold value. The value may be configured by the network through the measurement assistance information provided on a per QoS basis. If the RTT over the 3GPP link is greater than the absolute RTT threshold value, the UE 104 may not be restricted from offloading traffic and may apply a local configuration to determine whether it does so.

An embodiment may use a relative RTT threshold value by providing that the UE is to compare the RTT values of the two access paths. For example, the UE 104 may determine that no offload is available until the RTT of the 3GPP link is worse than the RTT of the non-3GPP link by more than the relative RTT threshold value (for example, more than 10%).

In various embodiments, the PM rules provided to the UE 104 in the PDU session establishment/modification accept message may provide the rules to apply to RTT measurements to determine whether to offload traffic along with the configured values/thresholds. In other embodiments, some or all of this information may be preconfigured to the UE 104 or provided to the UE 104 in another manner.

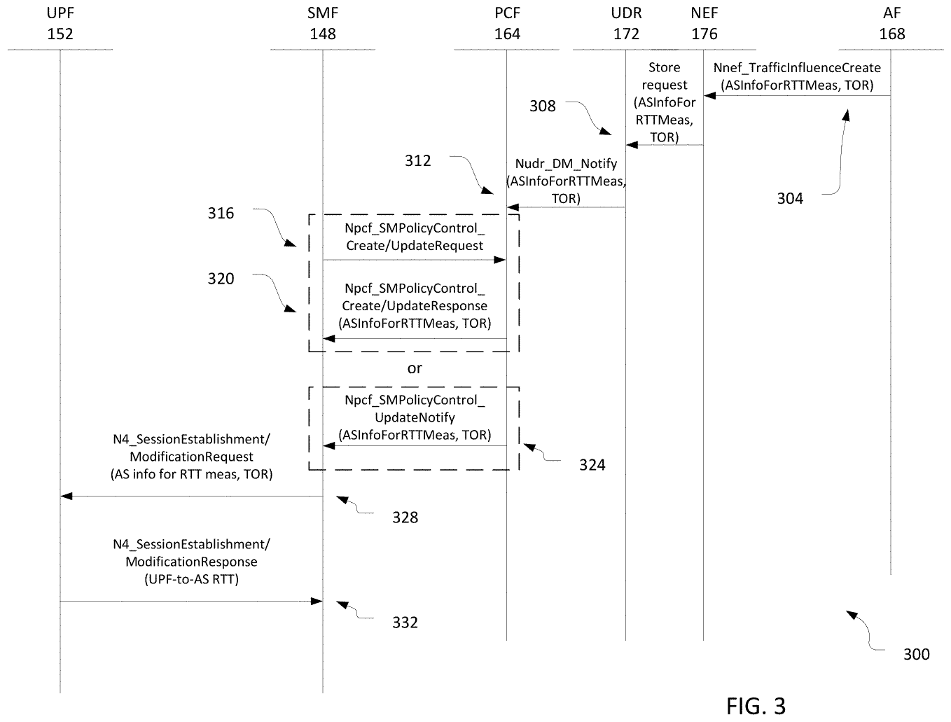

FIG. 3 illustrates a configuration operation 300 in accordance with some embodiments.

The configuration operation 300 may be used by the AF 168 to configure RTT measurement rules. The NEF interface, Nnef_TrafficInfluence, service may be enhanced to allow the AF 168 to configure offload rules that the UE 104 may apply based on EC RTT measurements. These offload rules may be based on absolute or relative thresholds as described above with respect to FIG. 2.

The AF 168 may use a traffic influence service to configure AS information for RTT measurements and traffic offload rules. In general, the traffic influence service may be used to authorize service consumer requests from network functions and perform mapping between parameters in the requests and parameters of the 5GC 140. To use the traffic influence service, the AF 168 may, at 304, transmit a Traffic Influence Create message (Nnef_TrafficInfluenceCreate) to the NEF 176. The Traffic Influence Create message may include AS information for RTT measurements (ASInfoForRTTMeas) and traffic offload rules (TOR). The AS information for RTT measurements may include an AS IP address/port number and a protocol to be used for measurements to obtain the UPF-to-AS RTT. The protocol, which may depend on the EAS 162, may be an Internet control message protocol (ICMP) or a PDU (IP packet) protocol. The traffic offload rules may be similar to that described above with respect to FIG. 2.

At 308, the NEF 176 may transmit a store request to the UDR 172. The store request may result in the UDR 172 storing the AS information for RTT measurements and traffic offload rules along with traffic influence parameters.

At 312, the UDR 172 may provide the AS information for RTT measurements and traffic offload rules to the PCF 164 in a notification message (Nudr_DM_Notify).

The AS information and traffic offload rules may be used by the PCF 164 to create a session management (SM) policy. The AS information for RTT measurements and traffic offload rules may be provided to the SMF 148 at the time of SM policy association establishment or modification. The AS information for RTT measurements and traffic offload rules may be provided through the SM policy association modification if the AS information is dynamically provided by the AF 168.

As shown in FIG. 3, the PCF 164 may transmit the AS information for RTT measurements and traffic offload rules to the SMF 148 as part of an SM policy control request/response procedure or an update procedure. In the first option, the SMF 148 may transmit an SM policy control request (Npcf_SMPolicyControl_Create/UpdateRequest) to the PCF 164 at 316. The PCF 164 may then provide the AS information for RTT measurements and traffic offload rules to the SMF 148 at 320 in the SM policy control response (Npcf_SMPolicyControl_Create/UpdateResponse). In the second option, the PCF 164 may provide the AS information for RTT measurements and traffic offload rules to the SMF 148 in an SM policy control update notification (Npcf_SMPolicyControl_UpdateNotify).

Upon receiving the AS information for RTT measurements, the SMF 148 may configure the UPF 152 with the same through an N4 session establishment/modification procedure. For example, at 328, the SMF 148 may transmit an N4 session establishment/modification request (N4_SessionEstablishment/ModificationRequest) with the AS information for RTT measurements to the UPF 152. At 332, the UPF 152 may respond by transmitting an N4 session establishment/modification response (N4_SessionEstablishment/ModificationResponse) to the SMF 148. The N4 session establishment/modification response may include measured RTT results (UPF-to-AS RTT meas), which may be an averaged RTT value. The measured RTT results may also be provided to the UE 104 in the PDU session establishment/modification procedure as discussed above with respect to FIG. 2.

The exchange of RTT information in the N4 session procedure may happen upon an association of an SDF to a QoS flow, when a UL CL/BP is inserted, when a UPF reselection occurs.

In an alternative to the configuration operation 300, the Nnef_AFSessionWithQos service and Npcf_PolicyAuthorization service may be updated to carry the AS information for RTT measurements and traffic offload rules. These services may be used by the NEF 176 to update the PCF 164. If the AF 168 is a trusted network function in the 5GC 140, the AF 168 may directly use the Nnef_AFSessionWithQos service to update the AS information for RTT measurements and traffic offload rules.

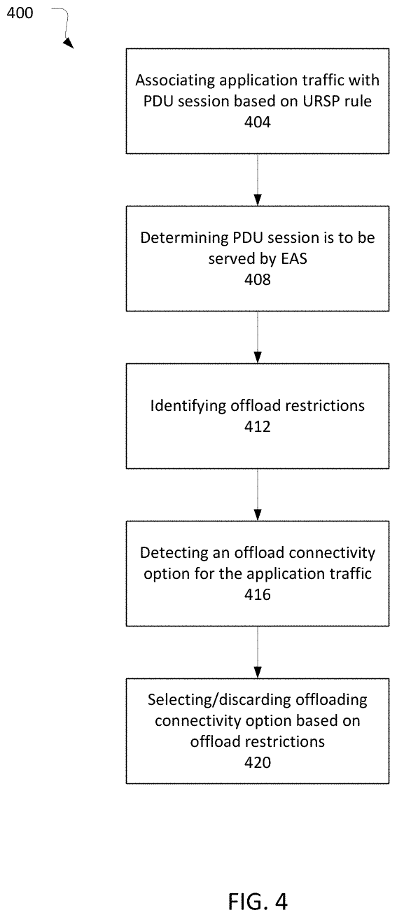

FIG. 4 illustrates an operation flow/algorithmic structure 400 in accordance with some embodiments. The operation flow/algorithmic structure 400 may be performed by a UE such as, for example, UE 104 or UE 700, or components thereof, for example, processing circuitry 704.

The operation flow/algorithmic structure 400 may include, at 404, associating application traffic with a PDU session based on a URSP rule. The PDU session may be an existing session or a yet-to-be-formed session. The URSP rule may include an offload guidance parameter set to true to indicate that a decision of offloading traffic that matches the traffic descriptor for the URSP rule is subject to offload restrictions.

The operation flow/algorithmic structure 400 may further include, at 408, determining the PDU session is to be served by an EAS. In some embodiments, the UE may receive a PDU session establishment or modification accept message that includes an edge DN indication that indicates that the PDU session is to be served by an EAS.

The operation flow/algorithmic structure 400 may further include, at 412, identifying offload restrictions. The offload restrictions may be identified based on the URSP rule including the offload guidance parameter and the determination that the PDU session is to be served by the EAS. In some embodiments, the offload restrictions may be a prohibition of offloading the application traffic to a non-3GPP access network. In other embodiments, the offload restrictions may set one or more conditions that must be present in order to offload the application traffic to the non-3GPP access network. These conditions may be based on an absolute RTT threshold value. For example, if an RRT value of the 3GPP link is less than the threshold value, the application traffic may not be offloaded to a non-3GPP link. Additionally/alternatively, these conditions may be based on a relative RTT threshold value. For example, if the RTT value of the non-3GPP link is less than the RTT value of the 3GPP link by the relative RTT threshold value (for example, 10%), the application traffic may be offloaded to the non-3GPP link.

The operation flow/algorithmic structure 400 may further include, at 416, detecting an offload connectivity option for the application traffic. For example, a UE may detect the presence of a suitable WLAN AP. The WLAN AP may be integrated with (or separate from) the 5GC providing the PDU session.

The operation flow/algorithmic structure 400 may further include, at 420, selecting or discarding the offload connectivity option based on the offload restrictions. For example, if the offload restrictions prohibit offloading of the application traffic, the offload connectivity option may be discarded and the application traffic may continue to be routed over the 3GPP access. In another example, if the offload restrictions provide conditions for offloading, the UE may acquire the additional information needed to determine whether the conditions are satisfied. For example, the UE may perform one or more RTT measurements over the 3GPP link and non-3GPP link. The RTT measurements may then be compared to the conditions. If the conditions are satisfied, the UE may select the offloading connectivity option and route the application traffic over the non-3GPP link. However, if the conditions are not satisfied, the UE may discard the offloading connectivity option.

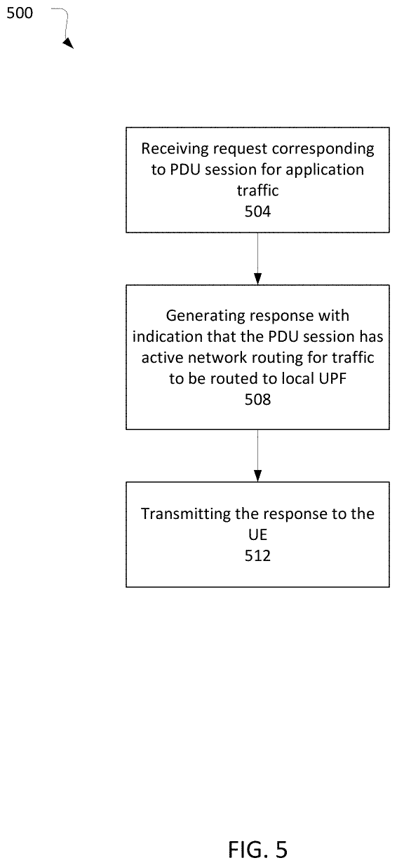

FIG. 5 illustrates an operation flow/algorithmic structure 500 in accordance with some embodiments. The operation flow/algorithmic structure 500 may be performed by an SMF such as, for example, SMF 148 or network node 800, or components thereof, for example, processing circuitry 804.

The operation flow/algorithmic structure 500 may include, at 504, receiving a request corresponding to a PDU session for application traffic from a UE. The request may be a PDU session establishment or modification request.

The operation flow/algorithmic structure 500 may further include, at 508, generating a response with an indication that the PDU session has active network routing for traffic to be routed to a local UPF. Thus, the PDU session is to be served by an EAS.

The operation flow/algorithmic structure 500 may further include, at 512, transmitting the response to the UE. The response may include an indication that the PDU session has active network routing. For example, the response may include an edge DN indication. In some embodiments, the response may be a PDU session establishment or modification accept request.

The response may additionally/alternatively include measurement assistance information to facilitate a determination by the UE of whether to offload the application traffic to a WLAN. The measurement assistance information may include a PMF address for RTT measurements on 3GPP access; one or more traffic offload rules (including, for example, relative or absolute RTT threshold values); or a PMF address for RTT measurements on non-3GPP access.

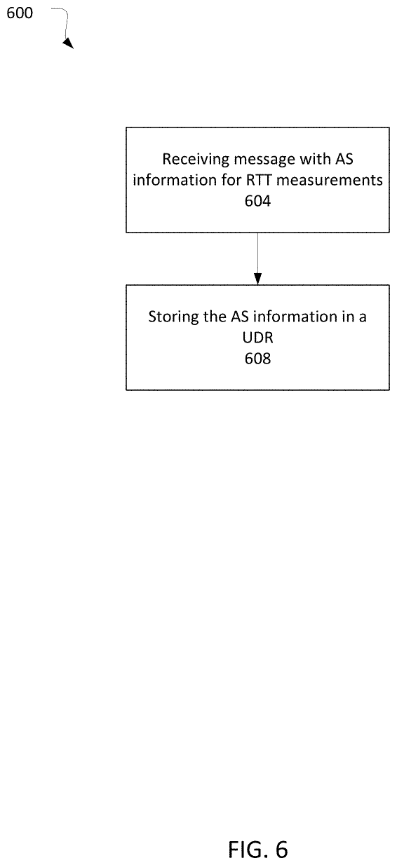

FIG. 6 illustrates an operation flow/algorithmic structure 600 in accordance with some embodiments. The operation flow/algorithmic structure 600 may be performed by an NEF such as, for example, NEF 176 or network node 800, or components thereof, for example, processing circuitry 804.

The operation flow/algorithmic structure 600 may include, at 604, receiving a message with AS information for RTT measurements. The AS information for RTT measurements may include an AS IP address or port number or a protocol to be used for RTT measurements. In some embodiments, the message may be part of a traffic influence service of the NEF interface. For example, the message may be a traffic influence create message received from an AF. In other embodiments, the message may be an AF session with QoS service message (Nnef_AFSessionWithQoS).

The operation flow/algorithmic structure 600 may further include, at 608, storing the AS information for RTT measurements in a UDR. The storing of the AS information may include sending a store request to a UDR.

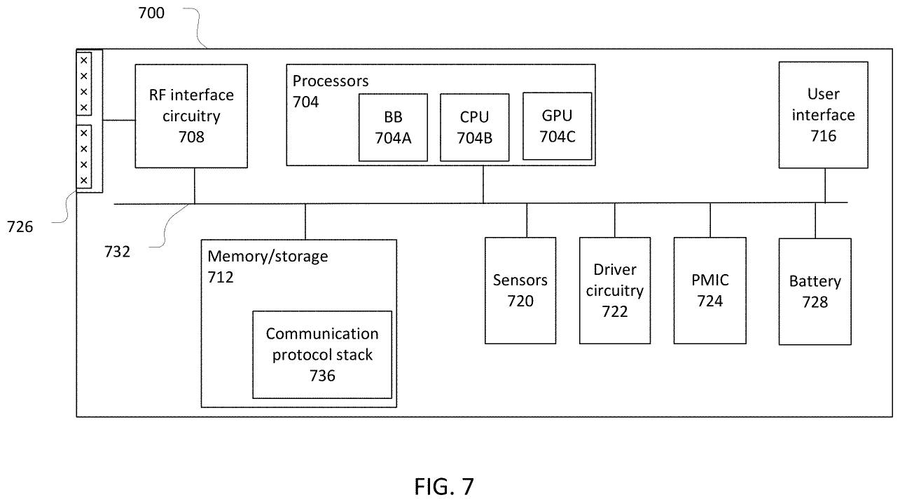

FIG. 7 illustrates a UE 700 in accordance with some embodiments. The UE 700 may be similar to and substantially interchangeable with UE 104 of FIG. 1.

The UE 700 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, or optical connection that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack 736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple input, multiple output communications. The antenna 726 may include microstrip antennas, printed antennas fabricated on the surface of one or more printed circuit boards, patch antennas, or phased array antennas. The antenna 726 may have one or more panels designed for specific frequency bands including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various I/O devices that may be present within, or connected to, the UE 700. For example, the driver circuitry 712 may include circuitry to facilitate coupling of a UICC (for example, UICC 148) to the UE 700. For additional examples, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700 including DRX as discussed herein.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

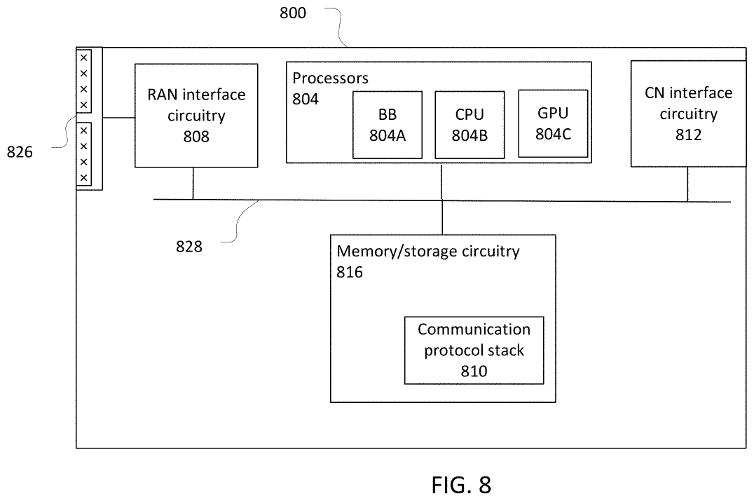

FIG. 8 illustrates a network node 800 in accordance with some embodiments. The network node 800 may be similar to and substantially interchangeable with a node providing any of the functions of the 5GC 140 such as those illustrated in FIG. 1.

The network node 800 may include processors 804, RF interface circuitry 808 (if implemented as an access node), core network (CN) interface circuitry 812, memory/storage circuitry 816, and antenna structure 826.

The components of the network node 800 may be coupled with various other components over one or more interconnects 828.

The processors 804, RF interface circuitry 808, memory/storage circuitry 816 (including communication protocol stack 810), antenna structure 826, and interconnects 828 may be similar to like-named elements shown and described with respect to FIG. 7.

The CN interface circuitry 812 may provide connectivity to a core network, for example, a 5^{th} Generation Core network (5GC) using a 5GC-compatible network interface protocol such as carrier Ethernet protocols, or some other suitable protocol. Network connectivity may be provided to/from the base station 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

In some embodiments, the network node 800 may be coupled with transmit receive points (TRPs) using the antenna structure 826, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: determining application traffic is associated with a user equipment (UE) route selection policy (URSP) rule that includes an offload guidance parameter; associating the application traffic to a protocol data unit (PDU) session based on the URSP rule; determining, based on an edge data network (DN) indication from a network, the PDU session is to be served by an edge application server; identifying offload restrictions based on the offload guidance parameter and said determining that the PDU session is to be serviced by the edge application server; detecting an offloading connectivity option for application traffic; and selecting or discarding the offloading connectivity option based on the offload restrictions.

Example 2 includes a method of example 1 or some other example herein, further comprising: receiving a PDU session establishment or modification accept message that includes the edge DN indication.

Example 3 includes method of example 2 or some other example herein, wherein the offload restrictions prevent offloading the application traffic based on the edge application server servicing the PDU session.

Example 4 includes a method of example 2 or some other example herein, wherein the PDU session establishment or modification accept message further includes measurement assistance information and the method further comprises: determining one or more round trip time (RTT) measurements on Third Generation Partnership Project (3GPP) access or non-3GPP access based on the measurement assistance information.

Example 5 includes a method of example 4 some other example herein, wherein the measurement assistance information includes an address of a performance measurement function.

Example 6 includes the method of example 4 some other example herein, wherein the PDU session establishment or modification accept message further includes one or more traffic offload rules and the method further comprises: identifying the offload restrictions based on the one or more traffic offload rules.

Example 7 includes the method of example 6 or some other example herein, further comprising: determining a measurement value based on the one or more the RTT measurements; comparing the measurement value to a threshold; and selecting or discarding the offloading connectivity option based on said comparing of the measurement value to the threshold.

Example 8 includes the method of example 7 or some other example herein, wherein the one or more RTT measurements includes an RTT measurement on 3GPP access and the measurement value is the RTT measurement on 3GPP access.

Example 9 includes the method of example 7 or some other example herein, wherein the one or more RTT measurements includes a first RTT measurement on 3GPP access and a second RTT measurement on non-3GPP access and the measurement value is based on a comparison of the first RTT measurement and the second RTT measurement.

Example 10 includes a method of example 9 or some other example herein, further comprising: determining a UE-to-user plane function (UPF) RTT time; determining a UPF-to-Application server (AS) RTT time; and adding the UE-to-UPF RTT time to the UPF-to-AS RTT time to determine the first RTT measurement.

Example 11 includes the method of example 10 or some other example herein, further comprising: receiving the UPF-to-AS RTT time from a session management function (SMF).

Example 12 includes the method of example 7 or some other example herein, wherein the measurement assistance information includes an indication of the threshold.

Example 13 includes a method of operating a session management function (SMF), the method comprising: receiving, from a user equipment (UE), a request corresponding to a protocol data unit (PDU) session for application traffic from the UE; generating a response with an indication that the PDU session has active network routing for traffic to be routed to a local user plane function (UPF); and transmitting the response to the UE.

Example 14 includes the method of example 13 or some other example herein, wherein the indication is an edge data network indication.

Example 15 includes the method of example 13 or some other example herein, wherein the request is a PDU session establishment or modification request and the response is a PDU session establishment or modification response.

Example 16 includes the method of example 13 or some other example herein, further comprising: generating the response to include measurement assistance information to facilitate a determination by the UE of whether to offload the application traffic to a wireless local area network (WLAN).

Example 17 includes the method of example 16 or some other example herein, wherein the measurement assistance information includes: a performance measurement function (PMF) address for round-trip time (RTT) measurements on Third Generation Partnership Project (3GPP) access; one or more traffic offload rules; or a PMF address for RTT measurements on non-3GPP access.

Example 18 includes the method of example 17 or some other example herein, wherein the measurement assistance information includes the one or more traffic offload rules that comprise an absolute threshold RTT value or an offset RTT value to be used by the UE to determine whether to offload the application traffic to the WLAN.

Example 19 includes the method of example 13 or some other example herein, further comprising: receiving, from a policy control function, application server (AS) information for round-trip time (RTT) measurements, wherein the AS information includes an Internet protocol (IP) address or port number associated with an AS or a protocol to be used for RTT measurements.

Example 20 includes the method of example 19 or some other example herein, wherein the AS information includes the protocol to be used for RTT measurements, wherein the protocol is an Internet control message protocol or a PDU protocol.

Example 21 includes the method of example 19 or some other example herein, further comprising: receiving the AS information for RTT measurements in a session management (SM) policy control message.

Example 22 includes the method of example 19 or some other example herein, further comprising: transmitting the AS information for RTT measurements to a user plane function (UPF) in an N4 session establishment or modification request.

Example 23 includes the method of example 13 or some other example herein further comprising: receiving a UPF-to-AS RTT measurement from the UPF in an N4 session establishment or modification response.

Example 24 includes a method of operating a NEF, the method comprising: receiving, from an application function, a message that includes application server (AS) information for round-trip time (RTT) measurements, wherein the AS information includes an Internet protocol (IP) address or port number associated with an AS or a protocol to be used for RTT measurements; and storing the AS information in a unified data repository (UDR).

Example 25 includes the method of example 24 some other example herein, wherein the message is a traffic influence create message and the method further comprises storing the AS information with traffic influence parameters in the UDR.

Example 26 includes a method comprising: determining application traffic is associated with a user equipment (UE) route selection policy (URSP) rule; associating the application traffic to a protocol data unit (PDU) session based on the URSP rule; detecting, in the URSP rule, an indication that the PDU session is enabled for edge computing (EC); detecting an offloading connectivity option for application traffic; and selecting or discarding the offloading connectivity option based on the indication.

Example 27 includes the method of example 26 or some other example herein, wherein the indication is in a route selection descriptor (RSD) of the URSP rule.

Example 28 includes the method of example 26 or some other example herein, wherein the indication is an EC-enabled PDU session component.

Example 29 may include an apparatus comprising means to perform one or more elements of a method described in or related to any of examples 1-28, or any other method or process described herein.

Example 30 may include one or more non-transitory computer-readable media comprising instructions to cause an electronic device, upon execution of the instructions by one or more processors of the electronic device, to perform one or more elements of a method described in or related to any of examples 1-28, or any other method or process described herein.

Example 31 may include an apparatus comprising logic, modules, or circuitry to perform one or more elements of a method described in or related to any of examples 1-28, or any other method or process described herein.

Example 32 may include a method, technique, or process as described in or related to any of examples 1-28, or portions or parts thereof.

Example 33 may include an apparatus comprising: one or more processors and one or more computer-readable media comprising instructions that, when executed by the one or more processors, cause the one or more processors to perform the method, techniques, or process as described in or related to any of examples 1-28, or portions thereof.

Example 34 may include a signal as described in or related to any of examples 1-28, or portions or parts thereof.

Example 35 may include a datagram, information element, packet, frame, segment, PDU, or message as described in or related to any of examples 1-28, or portions or parts thereof, or otherwise described in the present disclosure.

Example 36 may include a signal encoded with data as described in or related to any of examples 1-28, or portions or parts thereof, or otherwise described in the present disclosure.

Example 37 may include a signal encoded with a datagram, IE, packet, frame, segment, PDU, or message as described in or related to any of examples 1-28, or portions or parts thereof, or otherwise described in the present disclosure.

Example 38 may include an electromagnetic signal carrying computer-readable instructions, wherein execution of the computer-readable instructions by one or more processors is to cause the one or more processors to perform the method, techniques, or process as described in or related to any of examples 1-28, or portions thereof.

Example 39 may include a computer program comprising instructions, wherein execution of the program by a processing element is to cause the processing element to carry out the method, techniques, or process as described in or related to any of examples 1-28, or portions thereof.

Example 40 may include a signal in a wireless network as shown and described herein.

Example 41 may include a method of communicating in a wireless network as shown and described herein.

Example 42 may include a system for providing wireless communication as shown and described herein.

Example 43 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed by one or more processors, cause a device to:
determine application traffic is associated with a user equipment (UE) route selection policy (URSP) rule that includes an offload guidance parameter;
associate the application traffic to a protocol data unit (PDU) session based on the URSP rule;
determine, based on an edge data network (DN) indication from a network, the PDU session is to be served by an edge application server;
identify offload restrictions based on the offload guidance parameter and determination that the PDU session is to be serviced by the edge application server;
detect an offloading connectivity option for application traffic; and
select or discard the offloading connectivity option based on the offload restrictions.

2. The one or more non-transitory, computer-readable media of claim 1, wherein the instructions, when executed, further cause the device to:
receive a PDU session establishment or modification accept message that includes the edge DN indication.

3. The one or more non-transitory, computer-readable media of claim 2, wherein the offload restrictions prevent offloading the application traffic based on the edge application server servicing the PDU session.

4. The one or more non-transitory, computer-readable media of claim 2, wherein the PDU session establishment or modification accept message further includes measurement assistance information and the instructions, when executed, further cause the device to:
determine one or more round trip time (RTT) measurements on Third Generation Partnership Project (3GPP) access or non-3GPP access based on the measurement assistance information.

5. The one or more non-transitory, computer-readable media of claim 4, wherein the measurement assistance information includes an address of a performance measurement function.

6. The one or more non-transitory, computer-readable media of claim 4, wherein the PDU session establishment or modification accept message further includes one or more traffic offload rules and the instructions, when executed, further cause the device to:
identify the offload restrictions based on the one or more traffic offload rules.

7. The one or more non-transitory, computer-readable media of claim 6, wherein the instructions, when executed, further cause the device to:
determine a measurement value based on the one or more the RTT measurements;
compare the measurement value to a threshold; and
select or discard the offloading connectivity option based on comparison of the measurement value to the threshold.

8. The one or more non-transitory, computer-readable media of claim 7, wherein the one or more RTT measurements includes a first RTT measurement on 3GPP access and a second RTT measurement on non-3GPP access and the measurement value is based on a comparison of the first RTT measurement and the second RTT measurement.

9. The one or more non-transitory, computer-readable media of claim 8, wherein the instructions, when executed, further cause the device to:
determine a UE-to-user plane function (UPF) RTT time;
receive a UPF-to-Application server (AS) RTT time from a session management function (SMF); and
add the UE-to-UPF RTT time to the UPF-to-AS RTT time to determine the first RTT measurement.

10. The one or more non-transitory, computer-readable media of claim 7, wherein the measurement assistance information includes an indication of the threshold.

11. A method of operating a session management function (SMF), the method comprising:
receiving, from a user equipment (UE), a request corresponding to a protocol data unit (PDU) session for application traffic from the UE;
generating a response with an indication that the PDU session has active network routing for traffic to be routed to a local user plane function (UPF); and
transmitting the response to the UE.

12. The method of claim 11, wherein the indication is an edge data network indication.

13. The method of claim 11, wherein the request is a PDU session establishment or modification request and the response is a PDU session establishment or modification response.

14. The method of claim 11, further comprising:
generating the response to include measurement assistance information to facilitate a determination by the UE of whether to offload the application traffic to a wireless local area network (WLAN),
wherein the measurement assistance information includes: a performance measurement function (PMF) address for round-trip time (RTT) measurements on Third Generation Partnership Project (3GPP) access; one or more traffic offload rules that include an absolute threshold RTT value or an offset RTT value to be used by the UE to determine whether to offload the application traffic to the WLAN; or a PMF address for RTT measurements on non-3GPP access.

15. The method of claim 11, further comprising:
receiving, from a policy control function, application server (AS) information for round-trip time (RTT) measurements, wherein the AS information includes an Internet protocol (IP) address or port number associated with an AS or a protocol to be used for RTT measurements.

16. The method of claim 15, further comprising:
receiving the AS information for RTT measurements in a session management (SM) policy control message.

17. The method of claim 15, further comprising:
transmitting the AS information for RTT measurements to a user plane function (UPF) in an N4 session establishment or modification request.

18. The method of claim 11, further comprising:
receiving a UPF-to-AS RTT measurement from the UPF in an N4 session establishment or modification response.

19. An apparatus comprising:
memory having instructions; and
processing circuitry, coupled with the memory to execute the instructions to cause a network exposure function (NEF) to:
receive, from an application function, a message that includes application server (AS) information for round-trip time (RTT) measurements, wherein the AS information includes an Internet protocol (IP) address or port number associated with an AS or a protocol to be used for RTT measurements; and
store the AS information in a unified data repository (UDR).

20. The apparatus of claim 19, wherein the message is a traffic influence create message and the NEF is further to store the AS information with traffic influence parameters in the UDR.
